(19) United States
(12) Patent Application Publication
(10) Pub. No.: US 2007/0061294 A1
(43) Pub. Date: Mar. 15, 2007

(54) Source code file search

(75) Inventors: Korby Shane Parnell, Redmond, WA (US); Sanzib Khaund, Seattle, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 11/222,532

(22) Filed: Sep. 9, 2005

(51) Int. Cl. G06F 17/30

(52) U.S. Cl. 707/3

(57) ABSTRACT

A file search system and method are provided. The system and method can be employed, for example, to search computer programming source files (e.g., Visual Basic files, C++ files, etc.) to provide meaningful, context-based search results. The system can employ stored concatenated information associated with the search request to identify search results. The stored information can be based on directive(s) (e.g., “using” and/or “import” directive(s)) with corresponding variable declaration(s) to provide enhanced, “full-code” case sensitive or insensitive searches across source file(s). Additionally and/or alternatively, the system can facilitate “extrapolative” query(ies) in which a derived (or inherited) class(es) are returned based on a user's request. Optionally, search results can be scoped (e.g., identified by a single character), for example, by programming language.

### BACKGROUND

Developers and IT professional generally desire to create and share their code, craft, ideas, expertise, and “quick fix” utilities with like-minded developers and IT professionals. Many online sites exist which facilitate the exchange of programming ideas and/or examples. These sites can foster the formation and participation in vibrant communities based on, for example, a particular programming platform.

For example, programmers can review sample code based on the particular programming platform in order to more fully understand implementation details of constructs, methods, etc. The sample code can be a valuable tool for the programmer to identify ways in which other programmers have dealt with similar issues confronting the programmer.

Nevertheless, the ever increasing body of source code available has resulted in frustration in a user's inability to retrieve meaningful information. Conventional search engines typically employ full-text search algorithms work adequately for text-based documents such as word processing documents. However, full-text search algorithms employed to search computer programming source files can yield inappropriate and/or insufficient results leading to frustration.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A file search system and method are provided. The system and method can be employed, for example, to search computer programming source files (e.g., Visual Basic files, C++ files, etc.) to provide meaningful, context-based search results.

The system can include a concatenation search component that receives a search request, for example, from a user. The concatenation search component employs stored concatenated information associated with the search request to identify search results. The stored information can be based on directive(s) (e.g., “using” and/or “import” directive(s)) with corresponding variable declaration(s) to provide enhanced, “full-code” case sensitive or insensitive searches across source file(s). The concatenated information can be stored in a synonym index store (e.g., table) which can store an index of synonym(s) associated with particular search phrase(s) (e.g., variable(s), class(es), method(s), attribute(s), property(ies) etc.).

The concatenation search component can provide search results to a result component which can, for example, organize the results and/or provide the results to a user (e.g., via a display and/or email). The result component can provide hyperlink(s) to user sample(s) and/or public Workspace(s) that include file(s) containing the inferred search string. Additionally, the result component can provide a brief summary of the code resident in at least some of those files.

The results provided by the system can be context-based, meaningful example(s) of reference(s) to variable(s), class(es), method(s), attribute(s), property(ies) etc. requested by the user. The system can identify fully-qualified string(s) that appear in non-contiguous parts in searched files that are not found by conventional search engines (e.g., from text searches).

Additionally and/or alternatively, the system can facilitate “extrapolative” query(ies). The system can perform a derived (or inherited) class search based on a user's request, for example, “datagrid.[inherited]”. In this example, [inherited] is a tokenized keyword whose inclusion in the search string returns inherited instances of the DataGrid class. By performing an extrapolative query, the system, in essence, automatically appends “.[inherited]” to search string(s).

The system can include a relation search component that receives a request from a user and identifies derived (or inherited) class(es) based on the request (e.g., appending “.[inherited]” to search string(s)). The relation search component can employ a relation index store that stores information regarding relationship(s) between object(s) and/or instance(s) of object(s) (e.g., hierarchal information).

Optionally, search results can be scoped, for example, by programming language. For example, a user can request that only Visual Basic files be searched. In one example, the scope can be identified by a single character. For example, if a user desires to see only files containing Visual Basic code or attributed with a Visual Basic tag (e.g., because Visual Basic is the user's language of choice), the user can include a pre-defined, meaningful character, for example, the apostrophe ('). Similarly, in this example, a user can filter a result set for C++ files using the end of line semi-colon (;) and/ a “#” symbol for C# files.

To the accomplishment of the foregoing and related ends, certain illustrative aspects are described herein in connection with the following description and the annexed drawings. These aspects are indicative, however, of but a few of the various ways in which the principles of the claimed subject matter may be employed and the claimed subject matter is intended to include all such aspects and their equivalents. Other advantages and novel features of the claimed subject matter may become apparent from the following detailed description when considered in conjunction with the drawings.

### BRIEF DESCRIPTION OF THE DRAWINGS

FIG. 1 is a block diagram of a file search system.

FIG. 2 is a block diagram of a file search system.

FIG. 3 is a block diagram of a file search system.

FIG. 4 is a screen shot of a user interface.

FIG. 5 is a block diagram of a file information capture system.

FIG. 6 is a flow chart of a method of searching files.

FIG. 7 is a flow chart of a method of searching files.

FIG. 8 is a flow chart a method of storing file information.

FIG. 9 is a flow chart of a method of storing file information.

FIG. 10 illustrates an example operating environment.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form in order to facilitate describing the claimed subject matter.

As used in this application, the terms “component,” “handler,” “model,” “system,” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers. Also, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). Computer components can be stored, for example, on computer readable media including, but not limited to, an ASIC (application specific integrated circuit), CD (compact disc), DVD (digital video disk), ROM (read only memory), floppy disk, hard disk, EEPROM (electrically erasable programmable read only memory) and memory stick in accordance with the claimed subject matter.

Concatenation Search

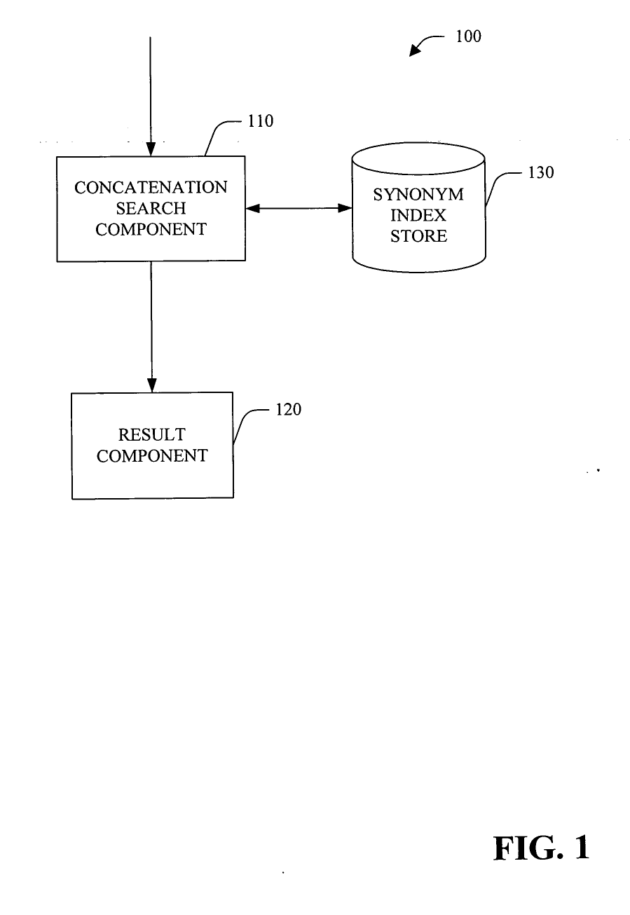

Referring to FIG. 1, a file search system 100 is illustrated. The system 100 can be employed, for example, to search source file(s) (e.g., Visual Basic files, C++ files, etc.) to provide context-based search result(s) to a user.

The system 100 includes a concatenation search component 110 that receives a search request, for example, from a user. The concatenation search component 110 employs stored concatenated information associated with the search request to identify search results. For example, the stored information can be based on directive(s) (e.g., “using” and/or “import” directive(s)) with corresponding variable declaration(s) to provide enhanced, “full-code” case sensitive or insensitive searches across source file(s).

The concatenation search component 110 can provide search results to a result component 120 which can, for example, organize the results and/or provide the results to a user (e.g., via a display and/or email). In one example, the result component 120 can provide hyperlink(s) to user sample(s) and/or public Workspace(s) that include file(s) containing the inferred search string. Additionally, the result component 120 can provide a brief summary of the code resident in at least some of those files.

The concatenation search component 110 can utilize a synonym index store 130 (e.g., table) to identify match(es) of a user's request. The synonym index store 130 can store an index of synonym(s) associated with particular search phrase(s) (e.g., variable(s), class(es), method(s), attribute(s), property(ies) etc.).

Accordingly, the result(s) provided by the system 100 can be context-based, meaningful example(s) of reference(s) to variable(s), class(es), method(s), attribute(s), property(ies) etc. requested by the user. Fully-qualified string(s) that appear in non-contiguous parts in searched files are not found by conventional search engines. For programmers, in particular, this is a problem because when looking for something, for example, System.IO.Directory, conventional search engines do not return files in which “Directory” implicitly references an instance of “System.IO” at a different place in the file. Thus, the system 100 can identify fully-qualified string(s) that appear in non-contiguous parts in searched files that are not found by conventional search engines (e.g., form text searches).

The “using” directive allows name(s) in a namespace to be used without the namespace-name as an explicit qualifier. With the “using” directive, the names in a namespace can be used without qualification. The “using” directive allows unique, descriptive names to be used when declaring functions and/or variables, without requiring the complete name every time access to the function(s) and/or variable(s) is needed.

The “import” directive explicitly imports a namespace into a page, making all classes and interfaces of the imported namespace available to the page. For example, the imported namespace can be part of the NET Framework class library and/or a user-defined namespace.

For example, a user requests samples for “System.Web.UI.WebControls.DataGrid”. A conventional, full-text search would only return files that contain the exact string the user submitted. However, the system 100 employs concatenation (e.g., of “using” and/or “import” directives) and returns:

```
Two (2) Search Results found for System.Web.UI.WebControls.DataGrid
===============================
Foo.cs in GotDotNet Workspace: ShadowFax
===============================
//C#
Using System.Web.UI.WebControls;
[...]
public class m1 : System.Web.UI.Page
{
protected DataGrid MyDataGrid
[...]
}
Void SubmitButton_Click(Object sender, EventArgs e)
{
  [...]
  MyDataGrid.DataSource = ds1;
  MyDataGrid.DataBind( );
}
===============================
bar.vb in GotDotNet User Sample: PolishCalc
===============================
‘Visual Basic
Imports System.Web.UI.WebControls
Public Class MyControl
  Public MyDataGrid As Datagrid
[...]
===============================
```

### EXAMPLE 1

In this example, the second search result provided by the system 100 would not have been provided by a conventional search engine as the exact text “System.Web.UI.WebControls.DataGrid” does not appear in the example. Instead, the second result employs the “import” directive to import System.Web.UI.Webcontrols. The system 100 thus recognizes the declaration of MyDataGrid As Datagrid is, in essence, MyDataGrid As System.Web.UI.WebControls.DataGrid. Further, if the user employs the system 100 to search for any of the following strings, the same results would be returned:

“WebControls.DataGrid”
“UI.WebControls.DataGrid”
“Web.UI.WebControls.DataGrid”

As each of these strings is synonymous with the System.UI.WebControls.DataGrid class.

For example, based on a user's request, the concatenation search component 110 can be case sensitive or case insensitive. Additionally, the concatenation search component 110 can employ Boolean search capability (e.g., AND, OR, NEAR, +, etc. . . . ). The concatenation search component 110 can further facilitate text searching on common word(s), for example, “this” or “me”. Finally, based on a user's request, the concatenation search component 110 can perform directory specific searches.

Derived and/or Inherited Class(es)

Derived (or inherited) classes are not returned by conventional search engines when a base class is provided as a search string, and vice versa. For example, if a user searches for “DataGrid”, traditional search engines do not return “SuperDataGrid”, which inherits from the DataGrid class, as a search result. For many developers who are attempting to solve a difficult coding problem, the ability to quickly find and reuse an existing class that achieves their objectives is very valuable. Doing so enables them to locate and reuse existing code rather than rewriting that which already exists.

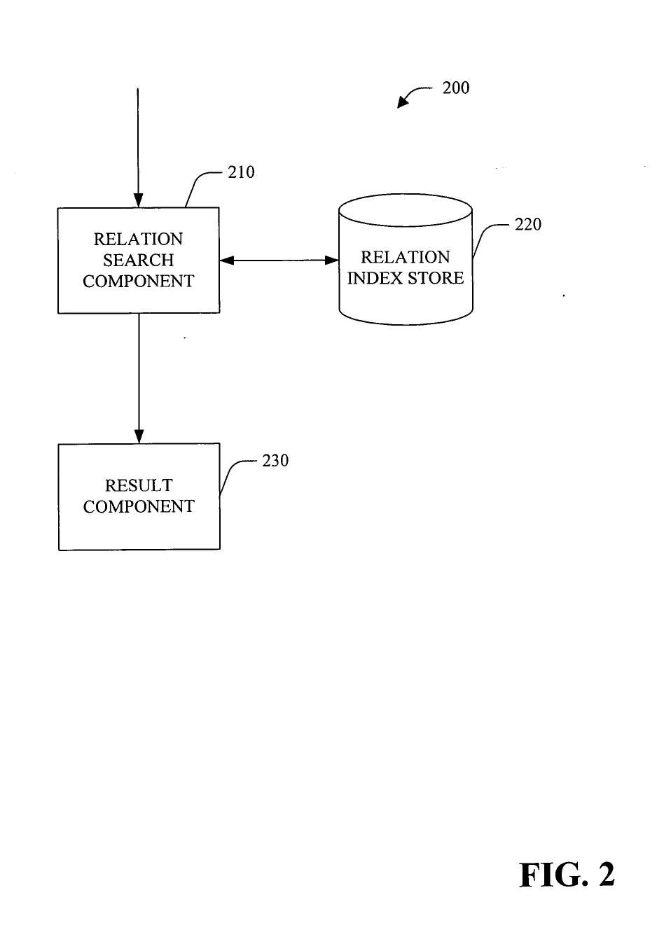

Turning to FIG. 2, a file search system 200 is illustrated. The system 200 facilitates “extrapolative” query(ies). The system 200 can perform a derived (or inherited) class search based on a user's request, for example, “datagrid.[inherited]”. In this example, [inherited] is a tokenized keyword whose inclusion in the search string returns inherited instances of the DataGrid class.

The system 200 can retrieve the instance(s) from one source file and then cross-check all others (canonically, public class MyDataGrid: System.Web.UI.WebControls.DataGrid). By selecting an “Extrapolative Query”, the system 200, in essence, automatically appends “.[inherited]” to search string(s). In one example, if a search string is not recognized as a class name and an extrapolative query is requested, for example, “casting examples”, the “.[inherited]” keyword can be ignored and the search is performed like any other full-text search.

The system 200 includes a relation search component 210 that receives a request from a user. The relation search component 210 identifies derived (or inherited) class(es) based on the request (e.g., appending “.[inherited]” to search string(s)). The relation search component 210 can employ a relation index store 220 that stores information regarding relationship(s) between object(s) and/or instance(s) of object(s) (e.g., hierarchal information).

For example, a user can attempt to implement a Web-based application that allows members of a work group to view, edit, sort, and update information in a tabular format. The user decides to use the .NET DataGrid control. After several hours, the user discovers that multi-row sorting doesn't work as expected and will require much additional work to perfect.

Frustrated, the user employs the file search system 100 discussed above with the search “datagrid+sorting” but is unsuccessful in retrieving useful samples. The user then employs the system 200 (which facilitates extrapolative query(ies)) and searches for “DataGrid”. The system 200 returns the string “SuperDataGrid” is highlighted in bold text. The user can then click on and download the SuperDataGrid project, which includes a class that inherits from the DataGrid class and which provides enhanced sorting capabilities.

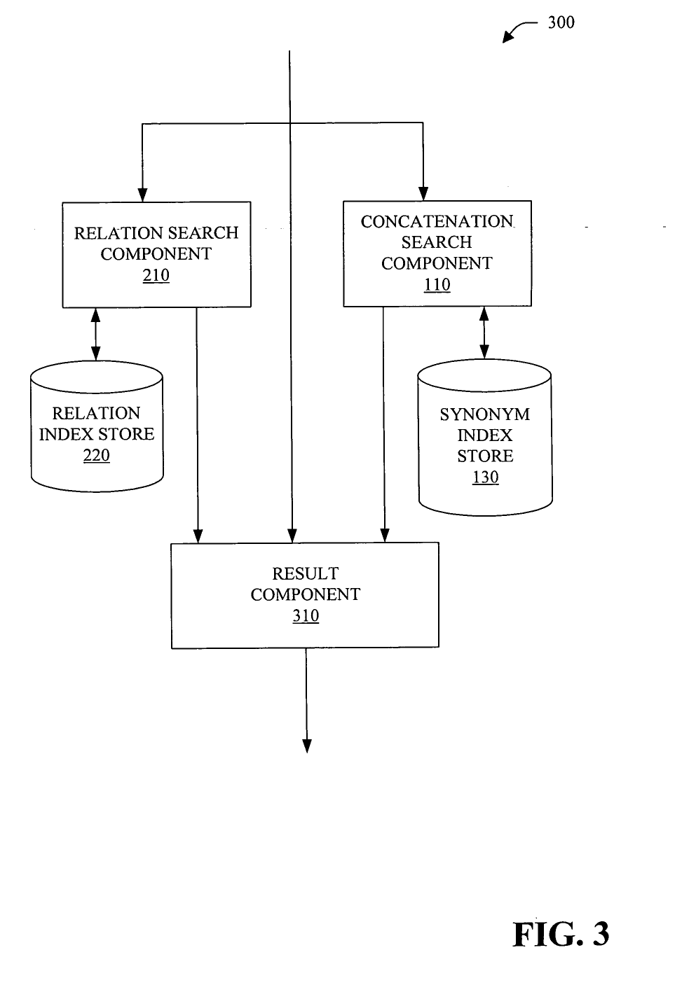

Turning to FIG. 3, a file search system 300 is illustrated. The system 300 facilitates searching, for example, of source file(s) (e.g., Visual Basic files, C++ files, etc.) to provide context-based search result(s) to a user.

The system 300 includes a concatenation search component 110 and a relation search component 210, as discussed above. The concatenation search component 110 concatenates directive(s) (e.g., “using” and/or “import” directive(s)) with corresponding variable declaration(s) to provide enhanced, “full-code” case sensitive or insensitive searches across source file(s). The concatenation search component 110 can utilize a synonym index store 130 to facilitate searching, as set forth previously.

The relation search component 210 can identify derived (or inherited) class(es) based on the request (e.g., appending “.[inherited]” to search string(s)). The relation search component 210 can employ a relation index store 220 that stores information regarding relationship(s) between object(s) and/or instance(s) of object(s) (e.g., hierarchal information).

The results of the concatenation search component 110 and/or the relation search component 210 can be provided to a result component 310. The result component 310 can organize the results and/or provide the results to a user (e.g., via a display and/or email). For example, result component 310 can provide hyperlink(s) to user sample(s) and/or public Workspace(s) that include file(s) containing the inferred search string. Additionally, the result component 310 can provide a brief summary of the code resident in at least some of those files.

Optionally, the concatenation search component 110, the relation search component 210 and/or the result component 310 can “scope” the search, for example, by programming language. For example, a user can request that only Visual Basic files be searched.

In one example, the scope can be identified by a single character. For example, if a user desires to see only files containing Visual Basic code or attributed with a Visual Basic tag (e.g., because Visual Basic is the user's language of choice), the user can include a pre-defined, meaningful character, for example, the apostrophe ('). Similarly, in this example, a user can filter a result set for C++ files using the end of line semi-colon (;) and/ a “#” symbol for C# files.

For example, a user initially submits a request to the system 300 which results in a large result set including examples in programming languages which are of not interest to the user. The user can resubmit the request with an optional search indicator to limit the result set to Visual Basic examples (since the user is a Visual Basic programmer).

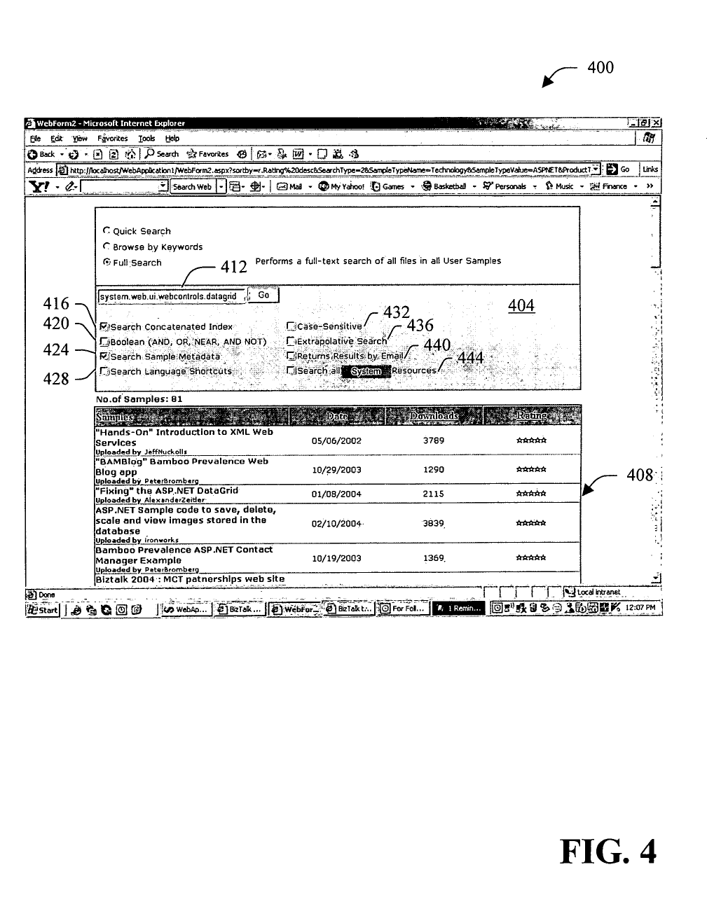

Referring next to FIG. 4, a user interface 400 is illustrated. For example, the user interface 400 can facilitate a user's interaction with the system 300.

The user interface 400 includes a search request area 404 and a search results area 408. With regard to the search request area 404, a user can provide information relevant to the search the user desires. For example, the user can provide information regarding variable(s), class(es), method(s), attribute(s), property(ies) etc. and/or text in a search request input field 412. Additional search option fields include: search concatenated index 416, Boolean search 420, search sample metadata 424, search language shortcuts 428, case-sensitive 432, extrapolative search 436, return results by email 440 and search all system resources 444.

For example, by selecting the search concatenated index 416 option, the system 300 employs the concatenated search component 110. By selecting the extrapolative search 436 option, the system 300 employs the relation search component 210. The return results by email 440 option can be utilized by the result component 310 to determine a desired mechanism for a user to receive results of the search by the system 300.

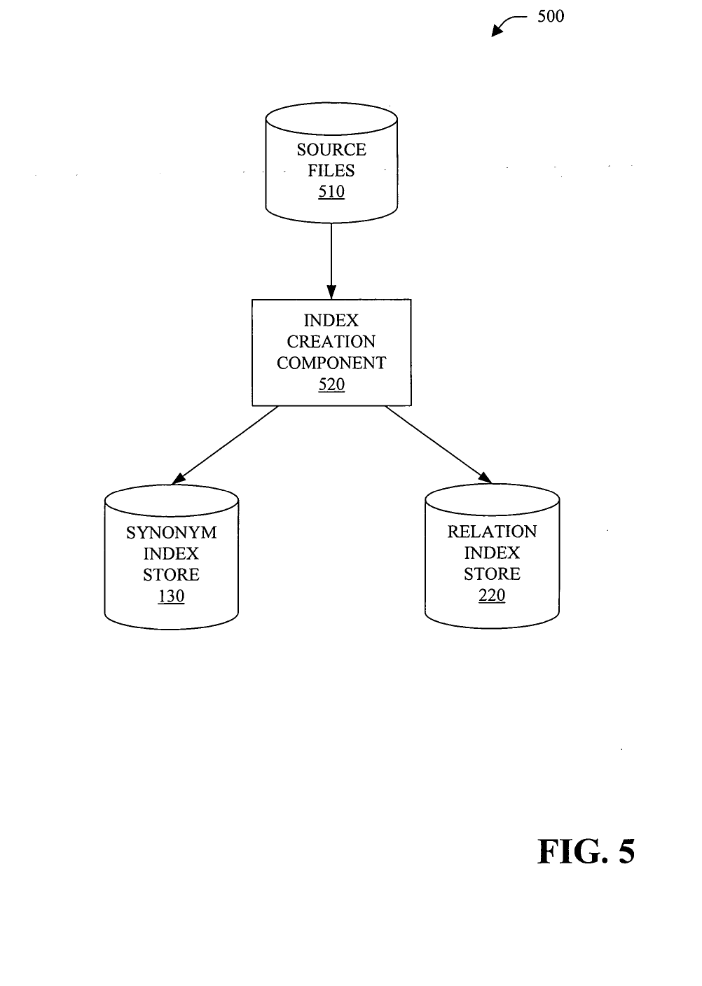

Referring next to FIG. 5, a file information capture system 500 is illustrated. The system 500 can be employed, for example, as part of a crawler that periodically indexes source files 510, creating index(es) for use by the file search system 100, 200 and/or 300. The system 500 includes an index creation component 520 that parses source files 510 to create, modify and/or update the synonym index store 130 and/or the relation index store 220.

With respect to the synonym index store 130, for a particular source file 510, the index creation component 520, can identify “using” and/or “import” directives provided in the particular source file 510. The index creation component 520 can review the source file 510 referred to by the “using” and/or “import” directive(s) in order to create a searchable index of synonyms for variable(s), class(es), method(s), attribute(s), property(ies) etc. of the particular file. For example, for the following code segment:

===============================
bar.vb in GotDotNet User Sample: PolishCalc
===============================
‘Visual Basic
Imports System.Web.UI.WebControls
Public Class MyControl
Public MyDataGrid As Datagrid
[...]

### EXAMPLE 2

the index creation component 520 can identify variable(s), class(es), method(s), attribute(s), property(ies) etc. associated with the “Imports System.Web.UI.WebControls” directive. The index creation component 520 can identify “Datagrid” as a synonym for “System.Web.UI.WebControls.DataGrid”. Thus, when “System.Web.UI.WebControls.DataGrid” is searched for (e.g., by the system 100 and/or 300), the code segment of Example 2 will be identified.

Additionally and/or alternatively, the index creation component 520 can parse information in source files 510 to create, modify and/or update the relation index store 220. For example, the index creation component 520 can store a hierarchy associated with one or more base classes in order that stores information regarding relationship(s) between object(s) and/or instance(s) of object(s) (e.g., hierarchal information).

For example, for a source file 510 that includes a “SuperDataGrid” class that inherits from a “DataGrid” class, the index creation component 520 can include an entry for the DataGrid class and associate with it the fact that the SuperDataGrid class inherits from it.

It is to be appreciated that the system 100, the concatenation search component 110, the result component 120, the synonym index store 130, the system 200, the relation search component 210, the relation index store 220, the result component 230, the system 300, the result component 310, the system 500 and/or the index creation component 520 can be computer components as that term is defined herein.

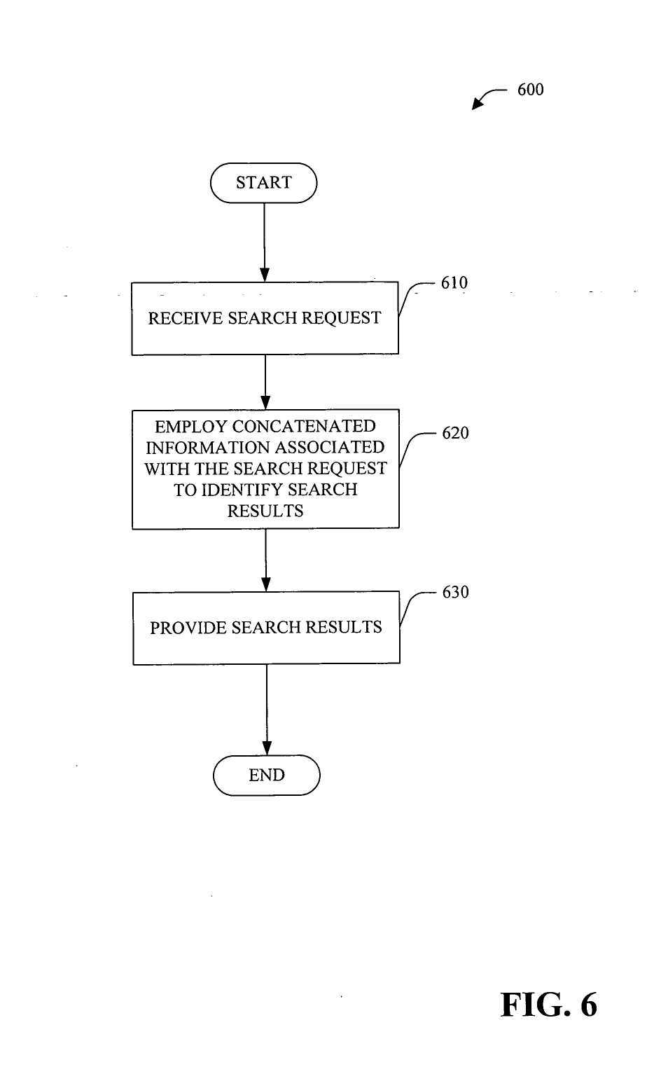

Turning briefly to FIGS. 6-9, methodologies that may be implemented in accordance with the claimed subject matter are illustrated. While, for purposes of simplicity of explanation, the methodologies are shown and described as a series of blocks, it is to be understood and appreciated that the claimed subject matter is not limited by the order of the blocks, as some blocks may, in accordance with the claimed subject matter, occur in different orders and/or concurrently with other blocks from that shown and described herein. Moreover, not all illustrated blocks may be required to implement the methodologies.

The claimed subject matter may be described in the general context of computer-executable instructions, such as program modules, executed by one or more components. Generally, program modules include routines, programs, objects, data structures, etc. that perform particular tasks or implement particular abstract data types. Typically the functionality of the program modules may be combined or distributed as desired in various embodiments.

Referring to FIG. 6, a method of searching files 600 is illustrated. At 610, a search request is received (e.g., from a user). At 620, concatenated information associated with the search request, for example, stored in a synonym index store 130, is employed to identify search results. At 630, the search results are provided (e.g., to the user).

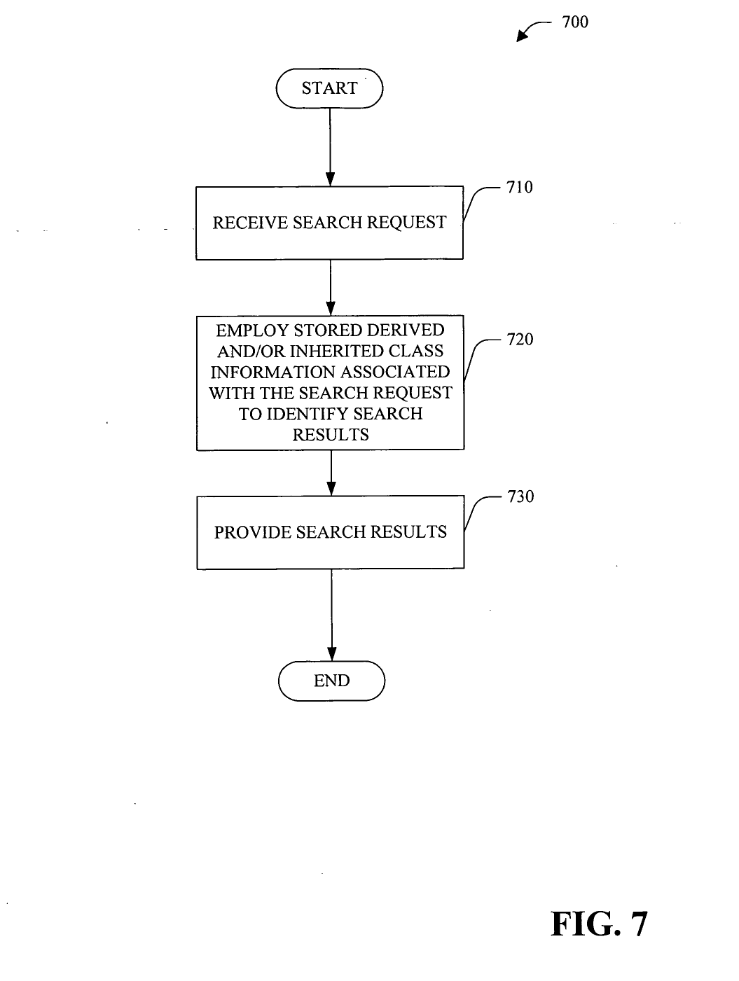

Turning to FIG. 7, a method of searching files 700 is illustrated. At 710, a search request is received (e.g., from a user). At 720, stored derived and/or inherited class information associated with the search request is employed to identify search results. At 730, the search results are provided (e.g., to the user).

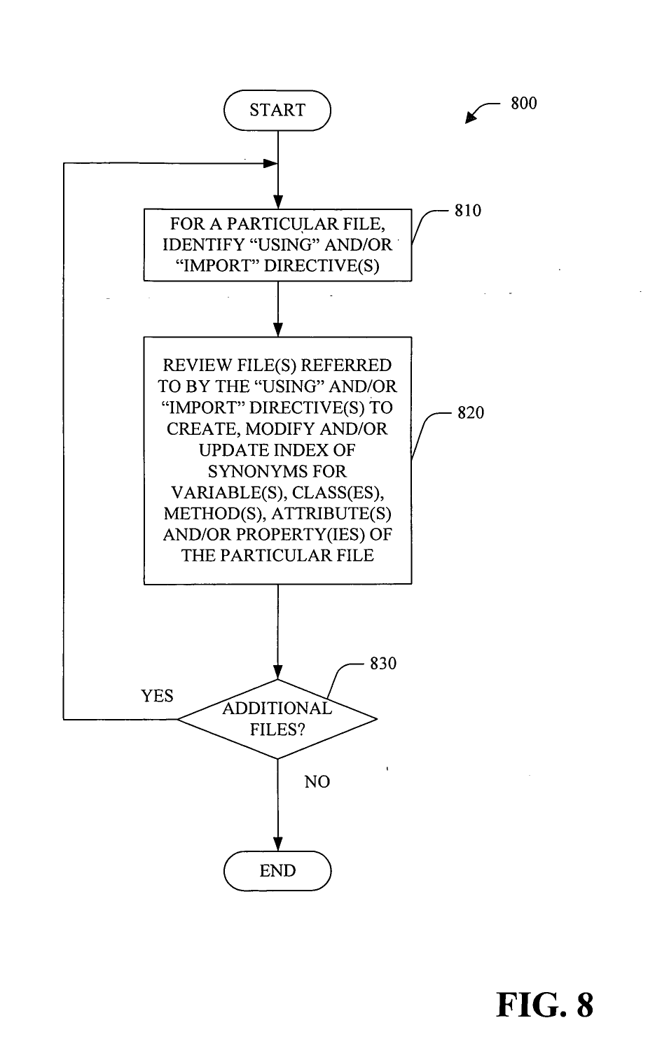

Next, referring to FIG. 8, a method of storing file information 800 is illustrated. At 810, for a particular file, “using” and/or “import” directive(s) are identified. At 820, file(s) referred to by the “using” and/or “import” directive(s) are reviewed to create, modify and/or update an index of synonyms for variable(s), class(es), method(s), attribute(s) and/or property(ies) of the particular file.

At 830, a determination is made as to whether additional files exist (e.g., to be indexed). If the determination at 830 is YES, processing continues at 810. If the determination at 830 is NO, no further processing occurs.

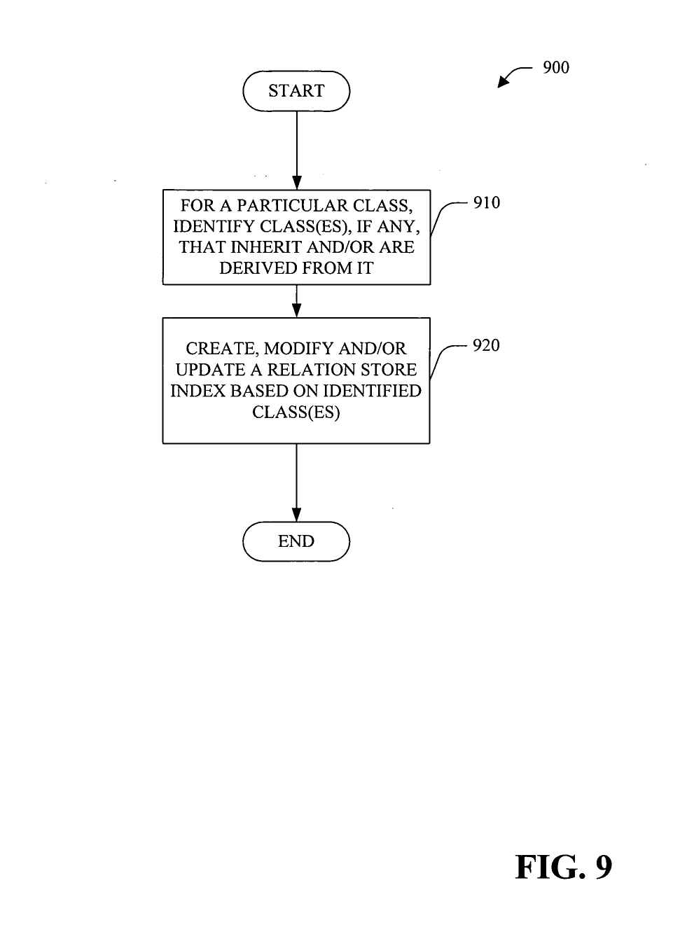

Turning next to FIG. 9, a method of storing file information 900 is illustrated. At 910, for a particular class, class(es), if any, that inherit and/or are derived from the particular class are identified. At 920, a relation store index is created, modified and/or updated based on the identified class(es).

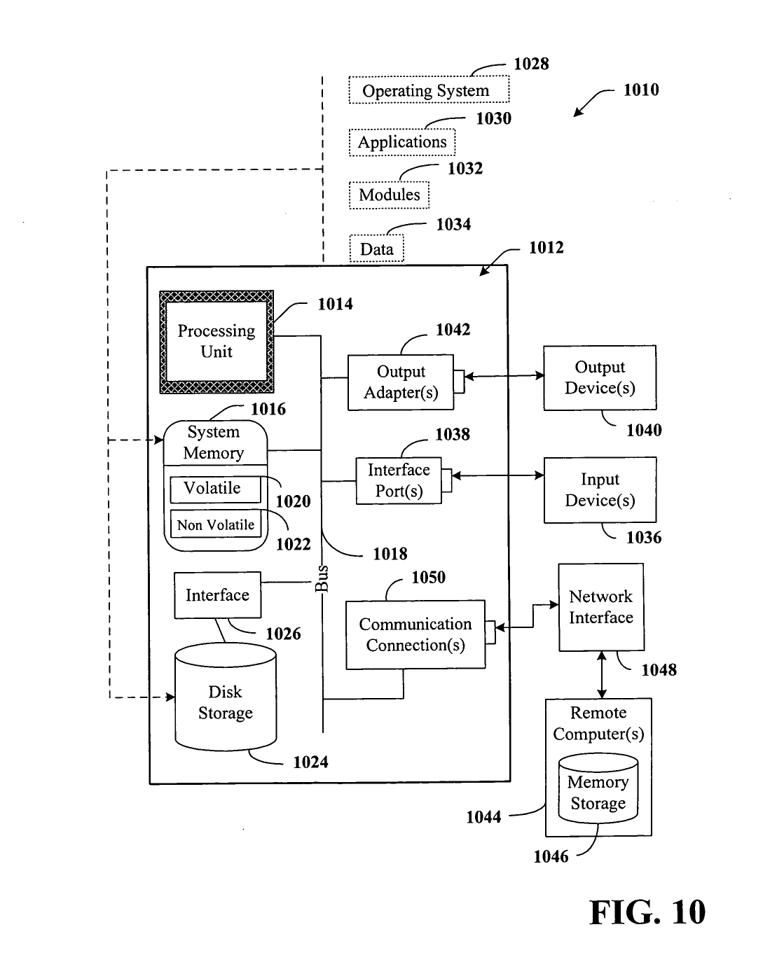

In order to provide additional context for various aspects of the claimed subject matter, FIG. 10 and the following discussion are intended to provide a brief, general description of a suitable operating environment 1010. While the claimed subject matter is described in the general context of computer-executable instructions, such as program modules, executed by one or more computers or other devices, those skilled in the art will recognize that the claimed subject matter can also be implemented in combination with other program modules and/or as a combination of hardware and software. Generally, however, program modules include routines, programs, objects, components, data structures, etc. that perform particular tasks or implement particular data types. The operating environment 1010 is only one example of a suitable operating environment and is not intended to suggest any limitation as to the scope of use or functionality of the claimed subject matter. Other well known computer systems, environments, and/or configurations that may be suitable for use with the claimed subject matter include but are not limited to, personal computers, hand-held or laptop devices, multiprocessor systems, microprocessor-based systems, programmable consumer electronics, network PCs, minicomputers, mainframe computers, distributed computing environments that include the above systems or devices, and the like.

With reference to FIG. 10, an exemplary environment 1010 includes a computer 1012. The computer 1012 includes a processing unit 1014, a system memory 1016, and a system bus 1018. The system bus 1018 couples system components including, but not limited to, the system memory 1016 to the processing unit 1014. The processing unit 1014 can be any of various available processors. Dual microprocessors and other multiprocessor architectures also can be employed as the processing unit 1014.

The system bus 1018 can be any of several types of bus structure(s) including the memory bus or memory controller, a peripheral bus or external bus, and/or a local bus using any variety of available bus architectures including, but not limited to, an 8-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 1016 includes volatile memory 1020 and nonvolatile memory 1022. The basic input/output system (BIOS), containing the basic routines to transfer information between elements within the computer 1012, such as during start-up, is stored in nonvolatile memory 1022. By way of illustration, and not limitation, nonvolatile memory 1022 can include read only memory (ROM), programmable ROM (PROM), electrically programmable ROM (EPROM), electrically erasable ROM (EEPROM), or flash memory. Volatile memory 1020 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 1012 also includes removable/nonremovable, volatile/nonvolatile computer storage media. FIG. 10 illustrates, for example a disk storage 1024. Disk storage 1024 includes, but is not limited to, devices like a magnetic disk drive, floppy disk drive, tape drive, Jaz drive, Zip drive, LS-100 drive, flash memory card, or memory stick. In addition, disk storage 1024 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1024 to the system bus 1018, a removable or non-removable interface is typically used such as interface 1026.

It is to be appreciated that FIG. 10 describes software that acts as an intermediary between users and the basic computer resources described in suitable operating environment 1010. Such software includes an operating system 1028. Operating system 1028, which can be stored on disk storage 1024, acts to control and allocate resources of the computer system 1012. System applications 1030 take advantage of the management of resources by operating system 1028 through program modules 1032 and program data 1034 stored either in system memory 1016 or on disk storage 1024. It is to be appreciated that the claimed subject matter can be implemented with various operating systems or combinations of operating systems.

A user enters commands or information into the computer 1012 through input device(s) 1036. Input devices 1036 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1014 through the system bus 1018 via interface port(s) 1038. Interface port(s) 1038 include, for example, a serial port, a parallel port, a game port, and a universal serial bus (USB). Output device(s) 1040 use some of the same type of ports as input device(s) 1036. Thus, for example, a USB port may be used to provide input to computer 1012, and to output information from computer 1012 to an output device 1040. Output adapter 1042 is provided to illustrate that there are some output devices 1040 like monitors, speakers, and printers among other output devices 1040 that require special adapters. The output adapters 1042 include, by way of illustration and not limitation, video and sound cards that provide a means of connection between the output device 1040 and the system bus 1018. It should be noted that other devices and/or systems of devices provide both input and output capabilities such as remote computer(s) 1044.

Computer 1012 can operate in a networked environment using logical connections to one or more remote computers, such as remote computer(s) 1044. The remote computer(s) 1044 can be a personal computer, a server, a router, a network PC, a workstation, a microprocessor based appliance, a peer device or other common network node and the like, and typically includes many or all of the elements described relative to computer 1012. For purposes of brevity, only a memory storage device 1046 is illustrated with remote computer(s) 1044. Remote computer(s) 1044 is logically connected to computer 1012 through a network interface 1048 and then physically connected via communication connection 1050. Network interface 1048 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1050 refers to the hardware/software employed to connect the network interface 1048 to the bus 1018. While communication connection 1050 is shown for illustrative clarity inside computer 1012, it can also be external to computer 1012. The hardware/software necessary for connection to the network interface 1048 includes, for exemplary purposes only, internal and external technologies such as, modems including regular telephone grade modems, cable modems and DSL modems, ISDN adapters, and Ethernet cards.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible.

Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A file search system comprising:
a concatenation search component that employs concatenated information associated with a search request to identify search results, the search results including at least one variable, class method attribute and/or property that only implicitly refers to the search request; and,
a result component that provides information associated with the search results to a user.

2. The system of claim 1, the concatenated information stored in a synonym index store.

3. The system of claim 2, the synonym index store comprising an index of synonyms associated with particular variables, classes, methods, attributes and/or properties of files to be searched.

4. The system of claim 2, information stored in the synonym index store by an index creation component that identifies “using” and/or “import” directives provided in files and reviews the files referred to by the directive in order to create the index of synonyms.

5. The system of claim 1, the search is case sensitive.

6. The system of claim 1, the search is case insensitive.

7. The system of claim 1 employed to search computer programming source files.

8. The system of claim 7, the computer programming source files based on at least one of Visual Basic, C++ and C#.

9. The system of claim 1, concatenation is based on a using and/or import directive of at least one of the files to be searched.

10. The system of claim 1, the result component provides a summary of code resident in at least some of the files that comprise the search results.

11. A file search system comprising:
a relation search component that employs stored derived and/or inherited class information associated with a search request to identify search results, the search results including at least one derived and/or inherited class associated with the search request; and,
a result component that provides information associated with the search results to a user.

12. The system of claim 11, the relation search component employs a relation index store that stores information regarding relationships between objects and/or instances of objects associated with files to be searched.

13. The system of claim 12, information stored in the relation index store by an index creation component that identifies and stores hierarchal information associated with classes associated with files to be searched.

14. The system of claim 11 employed to search computer programming source files.

15. The system of claim 14, the computer programming source files based on at least one of Visual Basic, C++ and C#.

16. A method of searching files comprising:
employing concatenated information associated with a search request to identify search results; and,
providing the search results.

17. The method of claim 16 further comprising storing the concatenated information by, for a particular file, identifying “using” and/or “import” directives, and, reviewing a file identified by the directive to create, modify and/or update an index of synonyms for variable(s), class(es), method(s), attribute(s) and/or property(ies) of the particular file.

18. The method of claim 16 further comprising employing stored derived and/or inherited class information associated with the search request to identify search results.

19. The method of claim 18 further comprising storing the derived and/or inherited class information by, for a particular class, identifying class(es), if any, that inherit and/or are derived from the particular class, and, creating, modifying and/or updating a relation store index based on the identified class(es).

20. The method of claim 16, the files are computer programming source files.
